(19) United States
(12) Patent Application Publication
(10) Pub. No.: US 2026/0258701 A1
(43) Pub. Date: Sep. 3, 2026

(54) DEPLOYABLE SHOE FOR A HEIGHT WORK PLATFORM

(71) Applicant: DUARIB GROUP, Romilly-sur-Andelle (FR)

(72) Inventors: Gontran MENAGER, Romilly-sur-Andelle (FR); Olivier MOREL, Romilly-sur-Andelle (FR)

(73) Assignee: DUARIB GROUP, Romilly-sur-Andelle (FR)

(21) Appl. No.: 19/489,999

(22) PCT Filed: May 22, 2024
(86) PCT No.: PCT/EP2024/064149

§ 371 Date: Dec. 4, 2025

(30) Foreign Application Priority Data
Jun. 7, 2023 (FR) FR2305721

(51) Int. Cl. E06C 1/20; E06C 1/39; E06C 1/397; E06C 7/18; E06C 7/42; E06C 7/46

(52) U.S. Cl. CPC E06C 1/20; E06C 1/39; E06C 1/397; E06C 7/185; E06C 7/423; E06C 7/46

(57) ABSTRACT

A height access device including a front leg, a rear leg, and a platform, the front leg defining a climbing plane including a step delimited by two spars and having two ground bearing feet, each equipped with a stabiliser rotatable between a storage position and a substantially horizontal deployed ground bearing position. Each stabiliser includes a fixed part and a movable part, the fixed part mounted to a leg of the front leg, the movable part rotatably mounted relative to the fixed part, externally to the space delimited by the spars of the front leg, between a deployed position and a folded position. The front leg includes wheels mounted to an elastic mechanism, the stabilisers distant from the ground and the wheels bearing on the ground while a user does not climb on the climbing plane, and locking mechanism holding the movable part in the deployed position.

The invention is directed to height access devices, in particular of the platform type.

“Platform” here means in particular mobile ladders with a platform, and more precisely mobile ladders with work platform with a maximum surface area of 1 m² and a maximum height of 5 m, designed for use by one person at a time. Such platforms are set forth in standard NF EN 131-7.

The invention especially relates to Individual Rolling Platforms (IRP) or Lightweight Individual Rolling Platforms (LIRP).

An individual rolling platform is typically a secure workstation that complies with standard NF P 93-352. An individual rolling platform is a platform used for elevated work, which can be carried and/or handled by crane in construction work by a single operator, working on a floor at a maximum height of 2.5 m above the ground. IRPs are equipped with a displacement means, an immobilisation means, and a workstation access means. Portable IRPs have a mass of less than 50 kg and can be foldable without disassembling their elements. IRPs are equipped with two wheels to allow handling them in a closed position. IRPs include a floor protected on three sides by fall protection means. These fall protection means include a toe board extending along three sides of the floor. When the user is at the workstation, the fall protection means include a handrail extending to the height of the user's torso and a sub-handrail extending to the height of the user's legs. A movable closure for the access to the workstation is provided. The presence of the operator on the platform must not be an obstacle to closing the access to the workstation. When the workstation opens outwards, standard NF P 93-352 stipulates that a locking system for the movable closure is mandatory.

Document FR2914683 shows an example of IRP.

A lightweight individual rolling platform is conventionally a secure workstation in accordance with standard NF P 93-353. A lightweight individual rolling platform is a platform used for elevated work, which can be carried and/or handled by crane in construction work by a single operator, working on a floor at a maximum height of 1.5 m above the ground. LIRPs are equipped with a displacement means, an immobilisation means, and a workstation access means. LIRPs have a mass less than 50 kg and can be foldable without disassembling their elements. LIRPs are equipped with wheels to allow handling them in a closed position. LIRPs include a floor that is protected on three sides by fall protection means. These fall protection means include a toe board extending along three sides of the floor. When the user is at the workstation, the fall protection means include a handrail extending to the height of the user's torso and a sub-handrail extending to the height of the user's legs. A movable closure for the access to the workstation is provided. The presence of the operator on the platform must not be an obstacle to closing the access to the workstation. When the workstation opens outwards, standard NF P 93-353 stipulates that a locking system for the movable closure is mandatory.

Document FR3023571 shows an example of LIRP.

Telescopic stabilisers extending transversely relative to the climbing plane, between a retracted position of transport of the platform to a deployed position of ground bearing are known. An example is provided in document FR2764320.

Such a design has drawbacks. In particular, releasing the stabilisers requires manual operation. Blocking in the released position also requires manual operation, most commonly the actuation of a lever.

Stand-forming stabilisers, fixedly positioned on each of the two spars of the climbing plane, are known. Such a design increases the overall size of the step or platform, which can hinder or even make it impossible to install or pass it into a corridor or door enframement.

Feet that are telescopic in relation to the spars of the climbing plane, with the feet provided with a projection at the lower part that extends transversely to the climbing plane, are known. One example is given in document FR2850703.

Such a design has drawbacks. Firstly, the protruding part across the legs increases the overall size of the step or platform, which can hinder or even make it impossible to install it in a corridor or door enframement.

Document FR3121166 describes a height access device comprising a front leg, a rear leg, and a floor, with the front leg comprising two ground bearing feet, each foot being provided with a stabiliser rotatably movable between a storage position and a substantially horizontal deployed ground bearing position, the angle defined between the storage position and the deployed position of each stabiliser on the front leg being at least 180°.

The structure described in document FR3121166 has several drawbacks.

Firstly, to place the stabiliser in its deployed state, the user must lift the leg of the platform, pivot the stabiliser with their foot by more than 180°, and then lower back the leg. The sequence of these three steps is mandatory and requires good coordination of arm and foot movements. These manoeuvres are tedious and tiring, especially since they have to be carried out on each leg.

Secondly, holding the stabilisers in the deployed position and folded position is ensured by spring washers. The effectiveness of these means proves to be unsatisfactory, and decreases over time, in particular due to friction wear.

Thirdly, in the folded position, the stabilisers extend vertically between the two spars of the climbing plane. The stabilisers therefore obstruct the passage when the user ascends the climbing plane.

Fourthly, regardless of whether the stabilisers are in the deployed or folded position, the platform leans on the ground with its four feet, each provided with a non-slip pad. The displacements of the platform are therefore tiring and demanding, with the user having to stand in front of the climbing plane. To displace the platform, it is indeed necessary to lift the front leg, to bring two rear wheels into contact with the ground.

The invention aims in particular to overcome the drawbacks of prior art, by providing a new stabilisation structure adapted to the platforms, in particular to IRPs or LIRPs, or to platforms used for product shelving.

For these purposes, the invention is directed, according to a first aspect, to a height access device comprising a front leg, a rear leg, and a floor, the front leg defining a climbing plane comprising at least one step extending in a space delimited by two spars, the front leg comprising two ground bearing feet, each foot being equipped with a stabiliser rotatably movable between a storage position and a substantially horizontal deployed ground bearing position, each stabiliser consisting of a fixed part and a movable part, the fixed part being mounted to a foot of the leg, the movable part being rotatably mounted to the fixed part about an axis, externally of the space delimited by the spars of the front leg, between a deployed position and a folded position, the front leg comprising wheels mounted to elastic means, the stabilisers of the front leg being distant from the ground and the wheels leaning on the ground as long as a user does not ascend onto the climbing plane, locking means being able to hold the movable part of each stabiliser in the deployed position.

The stabilisers are therefore movable in a space distinct from the internal space delimited by the spars of the climbing plane. The stabilisers, whether in the extended or folded position of the movable part, do not obstruct the feet of a user wishing to ascend or descend the front leg.

The stabilisers do not obstruct the displacement of the front leg, the stabilisers being distant from the ground and the device leaning on the ground with wheels, provided that a user is not on the climbing plane. Therefore, it is possible for a user to control rotation of the movable part of the stabilisers, advantageously using their foot, without needing to lift the front leg.

Advantageously, when the stabilisers of the climbing plane are in the deployed position, the locking means for each stabiliser include a section extending between the movable part and fixed part, the weight of a user climbing on the climbing plane causing the stabilisers to lean on the ground and the locking means to be clamped. After deployment, an unintentional foldback of the stabilisers is thus excluded as soon as a user climbs onto the climbing plane.

Advantageously, the fixed part of each stabiliser of the climbing plane is mounted externally to the space delimited by the spars of the front leg. The stabilisers thus do not hinder at all the feet of a user who wishes to climb up or down the climbing plane.

Advantageously, for each stabiliser of the climbing plane, the locking means are rotatably mounted to the fixed part, between a position for holding the movable part of the stabiliser in the deployed position and a position of releasing the movable part of the stabiliser. A return means is able to cause movement of the movable part from its deployed position to its folded position, when the locking means are in the release position. Returning to the folded, compact position for the stabilisers is thus achieved without any user intervention.

Advantageously, the displacement of the locking means from their holding position to their release position is performed against a return means. The risks of accidental actuation of the locking means are thus reduced.

In some implementations, the return means of the locking means is an elastic leaf, preferably made of spring steel.

In some implementations, the return means of the movable part comprises a torsion spring mounted to the axis of rotation of the movable part.

In some embodiments, the rear leg forms a stand comprising at least one crossbeam extending in a space delimited by two spars, the rear leg comprising two ground bearing feet, each foot being provided with a stabiliser rotatably movable between a storage position and a substantially horizontal deployed ground bearing position, each stabiliser comprising a fixed part and a movable part, the fixed part being mounted to a foot of the rear leg, the movable part being rotatably mounted with respect to the fixed part about an axis, externally to the space delimited by the spars of the rear leg, between a deployed position and a folded position, the rear leg comprising wheels mounted to elastic means, the stabilisers of the rear leg being distant from the ground and the wheels leaning on the ground as long as a user does not climb on the climbing plane, locking means being able to hold the movable part of each stabiliser of the rear leg in the deployed position.

The stabilisers of the rear plane thus do not hinder at all the displacement of the rear leg, as the stabilisers being distant from the ground and the device leaning on the ground with wheels, provided that a user is not on the climbing plane. It is thus possible for a user to control rotation of the movable part of the stabilisers, advantageously using their foot, without needing to lift the rear leg.

Advantageously, when the stabilisers of the rear leg are in the deployed position, the locking means of each stabiliser include a section extending between the movable part and fixed part, with the weight of a user climbing onto the climbing plane causing the rear leg stabilisers to bear on the ground and clamp the locking means. After deployment, an unintentional foldback of the stabilisers is thus excluded as soon as a user climbs onto the climbing plane.

Preferably, the fixed part of each stabiliser of the rear leg is mounted externally to the space delimited by the spars of the rear leg.

Advantageously, for each stabiliser of the rear leg, the locking means are movably mounted to the fixed part, between a position of holding the movable part of the stabiliser in the deployed position and a position of releasing the movable part of the stabiliser. A return means is able to cause movement of the movable part from its deployed position to its folded position, when the locking means are in the release position. Returning to the folded, compact position for the stabilisers is thus achieved without any user intervention.

In some implementations, the displacement of the locking means from their holding position to their release position is performed against a return means. The risks of accidental actuation of the locking means are thus reduced.

In some embodiments, the means for returning the locking means is an elastic leaf, preferably made of spring steel.

In some embodiments, the means for returning the movable part comprises a torsion spring, mounted to the axis of rotation of the movable part.

Advantageously, the device comprises a guardrail mounted to the front plane, this guardrail comprising a pair of lateral barriers, each mounted articulated to a spar between a deployed position, in which each barrier extends substantially perpendicularly to the front plane, and a folded back position.

According to another aspect, a device as set forth above is provided, the device being of the type known as an Individual Rolling Platform IRP, or a lightweight individual rolling platform.

Other objects and advantages of the invention will appear in light of the description of embodiments, made hereinafter with reference to the appended figures wherein:

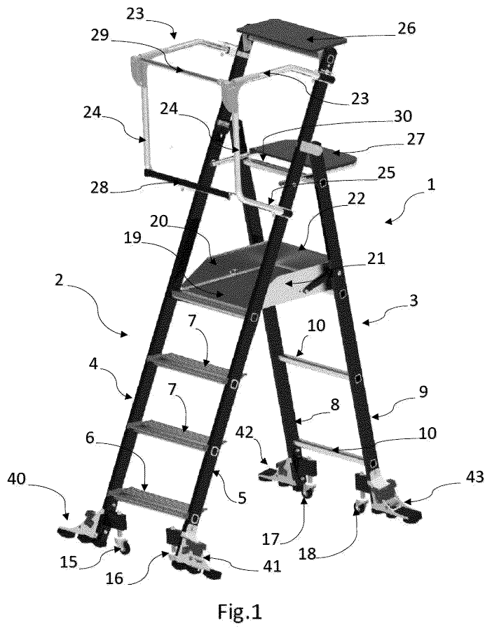

FIG. 1 is a perspective view of a platform according to one embodiment, with the climbing plane placed frontwardly;

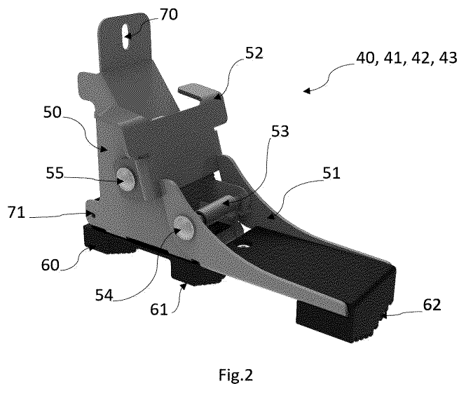

FIG. 2 is a perspective view of a stabiliser in the deployed position;

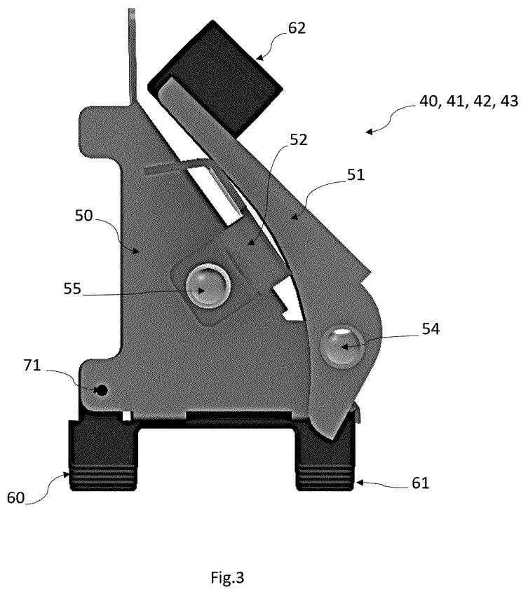

FIG. 3 is a perspective view of the stabiliser represented in FIG. 2, in its folded position;

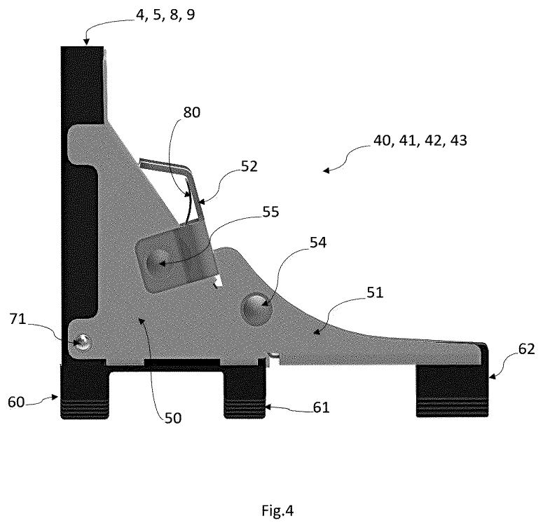

FIG. 4 is a perspective view of the stabiliser represented in FIG. 2, in the deployed position, with the stabiliser mounted to a spar foot of a leg.

In the remainder of this description, the terms “horizontal”, “vertical”, “up”, and “down” are used with reference to the platform in its deployed position, resting on the ground, as represented in FIG. 1, and the terms “left” and “right” are used with reference to a person standing in front of the platform and looking at the climbing plane.

Firstly, reference is made to FIG. 1, which represents a platform 1, according to one embodiment, the platform 1 being represented in a perspective view.

The platform 1 comprises two legs.

In the embodiment represented, the platform is easily accessible, with a first leg 2 forming a climbing plane and the second leg 3 forming a stand.

In other embodiments, not represented, the platform has dual access and comprises two legs, each forming a climbing plane.

In the embodiment represented in FIG. 1, the climbing plane comprises two spars 4, 5 and step-forming rungs 6, 7. The steps 6 and 7 advantageously include a beneficial non-slip leaning surface, wherein this surface may be embossed, ribbed, or perforated, for example. According to various embodiments, the steps 6 and 7 include an element in the form of a grid, a grating, expanded metal, or perforated metal. The steps 6 and 7 may be made of metal, especially aluminium alloy or steel, or a composite material.

In the embodiment represented, the second leg 3 comprises two spars 8, 9 and two crossbeams 10. The crossbeams 10 are in the form of a substantially horizontal bar.

In the embodiment represented, the climbing plane comprises three steps, and the platform is intended, for example, for product shelving, particularly in large retail environments (food supermarkets, large DIY centres).

In other embodiments, not represented, the climbing plane comprises one step, two steps, or more than three steps. The platform, for instance, includes five to seven steps, with a maximum working height of approximately three to four metres.

In some embodiments, the second leg comprises a lower crossbeam shaped in the form of a folded or curved tube, forming a U that opens towards the ground. This arrangement allows the platform to be employed over an obstacle such as a toilet bowl.

In the embodiment represented in FIG. 1, the climbing plane has a fixed height and comprises three steps.

In some embodiments, not represented, the climbing plane is height-adjustable and includes, for example, two telescopic assemblies, with the second leg also being height-adjustable.

In the embodiment represented in FIG. 1, each of the two spars 4, 5 of the climbing plane 2 carries a wheel 15 and 16. When a user wishes to displace platform 1, whether in the deployed or folded position, the wheels 15 and 16 are advantageously in contact with the ground. It is thus possible to displace the platform 1 manually and effortlessly. In the embodiment represented, each of the two spars 8 and 9 of the stand carries a wheel 17, 18, allowing the platform to be displaced either in the deployed position for use or in the compact folded position for transport.

In the embodiment represented, the displacement wheels are neither orientable nor load-bearing in the working position of the platform.

The two legs 1 and 2 are mounted articulated to each other, between a compact storage position in which the two legs are in contact and parallel to each other, and a position for using the platform, as represented in FIG. 1.

In some implementations, the platform includes a device for blocking the spars of the climbing plane when the platform 1 is in the compact folded position. In one implementation, the blocking device comprises deformable tabs forming an elastic hook. When the platform 1 is folded, the spars 4 and 5 of the climbing plane 2 move closer to those of the stand 3 and cause the elastic hooks to open. Blocking the spars 4, 5 of the climbing plane 2 is for example achieved by latching.

The platform 1 comprises a horizontal floor 19.

This floor 19 is advantageously non-slip and has, for example, a embossed, ribbed or perforated surface.

The floor may be made of metal, in particular of aluminium alloy or steel, or even of composite, for example with polymer matrix and glass fibre reinforcement.

A toe board delimits the floor 19, this toe board comprising three sections substantially perpendicular to the floor 19, namely two lateral sections 20, 21, and a junction section 22, opposite to the climbing plane.

This toe board limits the risks of falling objects such as tools that would be on the floor. This toe board forms a stop for the user's feet, reducing the risk of falling.

The height of the toe board is advantageously about ten centimetres or more than ten centimetres.

In one implementation, the floor and the toe board are made of a single piece, for example derived from injection moulding. In other implementations, the toe board is fastened to the floor. In some specific embodiments, the toe board is articulated to the floor, between a deployed position for use and a compact folded position for storage or transport of the platform.

The floor width is ideally forty centimetres, and its length is less than one metre. The platform is this adapted for indoor work and can be displaced through openings such as doorways or building stairs.

The platform 1 comprises a guardrail.

In the embodiment represented, the guardrail comprises a pair of lateral barriers, each formed by a bent or curved tube.

In other embodiments, not represented, one or both of the lateral barriers include a fabric net or a solid or perforated panel, for instance made of expanded metal or perforated metal.

The tubes forming the lateral barriers and the profiles forming the legs may especially be made of aluminium alloy or steel.

When the platform is intended for electrical work, the tubes forming the lateral barriers and the profiles forming the legs are advantageously made of insulating material, such as composite material, for example with a polymer matrix and glass fibre or flax fibre. Each lateral barrier is articulated and mounted to a spar 4, 5, between a deployed position, represented in FIG. 1, in which each barrier extends substantially perpendicularly to the front climbing plane, and a folded back position.

Advantageously, in the folded back position, each lateral barrier extends substantially parallel to the climbing plane. The platform is thus compact for storage or transport.

Each lateral barrier is articulated to its support spar by a top articulation and a bottom articulation.

Advantageously, blocking means allow each lateral barrier to be held in either its deployed position or its folded back position. These means comprise for example a safety pin.

Each lateral barrier includes an upper handrail section 23, a ramp 24, and a lower handrail section 25.

Advantageously, when the lateral barriers are in the deployed position, the upper handrail section 23 at least partly extends substantially horizontally, at the height of the torso of a user whose feet lean on the floor 19.

Advantageously, when the lateral barriers are in the deployed position, the lower handrail section 25 extends substantially to the height of the legs of a user whose feet lean on the floor 19.

In the embodiment represented, the two barriers have a similar structure and are mirror images of each other in relation to a vertical plane.

Advantageously, the two lateral barriers are formed by cutting, folding, bending, and assembly, from a same metal tube, for example an aluminium alloy tube with a round cross-section, or a composite tube, for example derived from pultrusion.

The spars 4 and 5 of the climbing plane 1 have a greater length than the spars 8 and 9 of the stand 2, and the platform 1 is equipped with a shelf 26, fastened at the upper end of the spars 4 and 5 of the climbing plane.

In some implementations, this shelf 26 is made from polymer material or composite material.

The functions of the shelf 26 are adaptable to the intended uses for the platform 1, with the shelf capable of serving as a tool holder, and/or as a support for either a flexible or rigid toolbox, and/or as a support for a container, such as a paint can.

In the embodiment represented, the shelf 26 provides a smooth leaning surface. In other implementations, not represented, the shelf includes one or more grooves or housings, for example for tools.

Depending particularly on the loads in service, fastening the shelf 26 to the spars 4, 5 of the climbing plane may be carried out by interference fitting, or by screwing or riveting. The two spars 4 and 5 of the climbing plane 2 delimit a circulation space for the user's body while ascending to and descending from the platform 1.

A working space is delimited laterally by the upper sections of the spars 4, 5 of the climbing plane, and the upper sections of the spars 8, 9 of the rear stand.

This workspace is secured, in particular with regard to falling hazards, at different heights of the body of the user whose feet lean on the floor 19.

A first safety device, at the height of the user's feet, is provided by the three sections 20-22 of the toe board.

A second safety feature, at the height of the user's legs, is provided by the lower sections 25 of the lateral barriers and by a strip or strap 28, forming a guardrail lower handrail.

A third safety feature, at the height of the user's torso, is provided by the upper sections 23 and by an upper bar 29 mounted articulated to a lateral barrier.

In the embodiment represented, the upper bar 29 is pivotably mounted articulated to the lateral barrier disposed on the left of the climbing plane.

It is understood that the upper bar 29 could be pivotably mounted articulated to the lateral barrier disposed on the right of the climbing plane.

Advantageously, the upper bar 29 is rigid and is made, for instance, of steel, aluminium alloy, or composite material.

The lower 23 and upper 24 sections of the lateral barriers provide the user with safety against lateral tipping of the platform.

Safety concerning the forward tipping of platform 1 is ensured by the presence of the shelf 26 at the height of the user's torso, and by the presence of a crossbeam 30 connecting the spars 8 and 9 of the stand, at the height of the user's legs.

Advantageously, a crossbeam is disposed beneath the shelf 26, this crossbeam being assembled to the spars 4, 5, wherein this crossbeam can serve as a leaning surface for the shelf 26 and enhancing safety against the platform tipping forward.

Safety against the backward tipping of the platform 1 is ensured by the presence of the upper bar 29, at the rear of the workstation, at the height of the user's torso, and by the presence of the lower strip or strap 28, at the height of the user's legs.

Full safety of the workspace, over 360°, is thus provided to the user of the platform.

Advantageously, the platform is provided with means prohibiting accidental outward opening of the workstation, for instance when the user present in the workspace leans on the upper bar 29 or the lower strip 28.

In the embodiment represented in FIG. 1, no member of the platform projects above the upper sections 23 of the guardrail. The user present in the workspace thus benefits from 360°safety, with no members of the platform obstructing their view or arm movements.

Advantageously, the area of floor 19 is inscribed in the lift polygon of the platform 1. This greatly reduces the risk of the platform tipping over during use.

The bar 29 forms an upper handrail for the guardrail.

Advantageously, manually opening the guardrail by pivoting the bar 29 is only possible when a vertical force is applied to the bar 29, from the bottom upwards.

In some implementations, this force is applied against a return means.

The orientation of such a force rules out the possibility of it happening unintentionally. The stiffness of the possible return means is advantageously relatively high, eliminating any risk of accidental opening of the gate.

Advantageously, the upward pivoting stroke of the bar 29 is restricted to limited to less than 30°, and even more advantageously to less than 20°, in relation to the horizontal position of the bar 29, this horizontal position being the closure position of the workstation.

This limited upward stroke of the bar 29 does not enable the user on the platform 1 to leave the workstation and is only implemented to unhook bar 29 from its bearing point. When the bar 29 has been unhooked from its bearing point, a pivoting manual movement of the bar is possible, by pivoting downwards anticlockwise, for an observer placed in front of the climbing plane.

When the user wishes to leave the elevated workstation, the bar 29 must be manually manoeuvred in a clockwise direction.

This downward pivoting movement, in a clockwise direction, is advantageously performed until it reaches a storage position, in which the bar 29 is substantially vertical. This manoeuvre is facilitated by the own weight of the bar 29.

In some implementations, this clockwise pivoting movement is carried out against a return means, for example a torsion spring. These arrangements help to avoid a sudden movement of the bar 29.

Advantageously, pivoting the bar 29 about its axis is not performed along a vertical plane, and includes a horizontal component.

The presence of this horizontal component reduces the risk of accidentally unhooking the bar: the user must apply a horizontal force, followed by a vertical upward force, and then lower the bar to transition the bar from its deployed horizontal position to its vertical storage position.

The strap or strip 28 is equipped with fastening mechanisms on both lateral barriers. Advantageously, the strap 28 is permanently attached to one of the lateral barriers, for instance the left lateral barrier, and the strap 28 is equipped with means for mounting and dismounting to/from the second lateral barrier.

In some embodiments, the strap 28 is slightly elastically deformable. In other implementations, the strap 28 has high stiffness and is weakly elastically deformable. The strap is made, for instance, of coated fabric, polymer materials such as polyester or aramid, or even leather.

In the embodiment represented in FIG. 1, platform 1 comprises a lower shelf 27, at the height of the legs of a user whose feet are on the floor 19. This shelf 27 can, for example, serve as a bearing point for a bucket such as a paint pot.

The platform advantageously comprises stabilisers, either on the climbing plane or on the second leg.

In the embodiment represented in FIG. 1, the platform 1 comprises two stabilisers 40 and 41 on the climbing plane 2, and two stabilisers 42 and 43 on the second leg 3, with stabilisers 40 to 43 being advantageously back foldable.

In the embodiment represented, the two stabilisers 40 and 41 fastened to the lifting plane 2 are essentially identical to the two stabilisers 42 and 43 fastened to the second leg 3.

In other embodiments, not represented, the stabilisers fastened to the lifting plane define a ground bearing surface of a different extent compared to that defined by the stabilisers fastened to the second leg.

In the following description, the structure of a stabiliser 40-43 will be detailed with reference to FIGS. 2 to 4.

When a user is in front of the climbing plane, the right-hand spar of the climbing plane carries a stabiliser, whose unfolding movement is achieved by rotating it clockwise. The left-hand spar of the climbing plane carries a stabiliser whose unfolding movement is achieved by rotating it anticlockwise.

As the spars 4 and 5 delimit an interior space at the climbing plane, unfolding the stabilisers 40 and 41 is achieved in a space external to the climbing plane.

Conversely, the foldback movement of the stabiliser carried by the right-hand spar of the climbing plane is achieved by rotating it anticlockwise. The foldback movement of the stabiliser carried by the left spar of the climbing plane is achieved by rotating it clockwise.

Foldback of the stabilisers 40 and 41 of the climbing plane is achieved in a space external to the climbing plane.

What has just been said about the stabilisers 40 and 41 of the climbing plane 2 also advantageously applies to the stabilisers 42 and 43 fastened to the second leg 3.

Unfolding allows for the extension, deployment, opening, and spreading of a stabiliser 40-43, with the unfolded stabiliser disposed facing a larger surface area of the ground than in the folded, folded back, state of the stabiliser.

The stabiliser is therefore movable between a compact position for storage or transport of the platform, and an extended position for use of the platform.

When the stabilisers are in the compact position, the platform has a reduced overall size.

Advantageously, the width of the climbing plane and the second leg is less than 750 mm, preferably less than 700 mm, and even more advantageously less than 630 mm, when the stabilisers are in the folded position. This makes the platform suitable for passing through the openings of interior doors in homes.

When the stabilisers are in the extended position, the platform offers high stability.

Advantageously, the width of the climbing plane and the second leg is greater than 850 mm, even more advantageously greater than 890 mm, when the stabilisers are in the deployed position. The platform therefore has a high tipping resistance.

In the embodiment represented, each stabiliser 40-43 comprises a first part, referred to as the fixed part 50, a second part, referred to as the movable part 51, a locking means 52, and at least one return means 53.

The fixed part 50 is provided with means for mounting the stabiliser 40-43 to a spar 4, 5 of the climbing plane 2 or to a spar 6, 7 of the second leg 3.

The movable part 51 is movably mounted to the fixed part 50, between a deployed position and a compact position of the stabiliser 40-43.

In the embodiment represented, the movable part 51 is rotatably mounted about a substantially horizontal axis 54, over a stroke of approximately 130°. The axis of rotation 54 is disposed at a low height relative to the ground.

The locking means 52 is able to hold the movable part 51 in the deployed position, provided that the user does not request folding back of the stabiliser 40-43.

In the embodiment represented, the locking means 52 is rotatably mounted to the fixed part 50 about a substantially horizontal axis 55, over a stroke of a few degrees.

The locking means 52 is movable between a holding position and a release position, against a return means, such as a spring steel leaf 80.

In the embodiment represented, in the holding position visible in FIGS. 2 and 3, a section of the locking means 52 is inserted between the fixed part 50 and the movable part 51, and blocks rotation of the movable part 51. The stabiliser 40-43 is therefore held in its deployed position.

In the embodiment represented, in the release position of the locking means 52, represented in FIG. 4, the movable part 51 is free to pivot about the axis 54 relative to the fixed part 50, either in a clockwise direction or in an anticlockwise direction.

The return means 53 is able to automatically cause the movement of the movable part 51, from its deployed position to its compact position, when the user requests folding back of the stabiliser 40-43.

In the embodiment represented, the return means 53 is a torsion spring, the turns of which are mounted to the axis of rotation 54 of the movable part 51. One end of the torsion spring is bearing against the movable part 51.

In some implementations, the other end of the torsion spring is bearing against the locking means 52.

In the embodiment represented, when the stabiliser 40-43 is in the deployed position, controlling foldback of the stabiliser is carried out by pressing on the locking means 52 and vertically pressing downwardly on the movable part 51 of the stabiliser.

Advantageously, the platform 1 includes wheels 15-18 mounted to elastic means, such as compression springs. Therefore, as long as the user does not climb the climbing plane, the stabilisers 40 and 41 of the climbing plane are placed at a distance from the ground, with wheels 15 and 16 bearing on the ground. Similarly, as long as the user does not apply any force to the crossbeams of the second leg 3, the stabilisers 42 and 43 of the second leg 3 are placed at a distance from the ground, with wheels 17 and 18 bearing on the ground.

By way of indication, the stabilisers are therefore a few millimetres from the ground, for instance around 20 mm, especially 18 mm.

It is thus possible to easily displace the platform. A user can control deployment of the stabilisers without having to lift the front leg or rear leg.

Conversely, when a user climbs onto or descends from the climbing plane, or when a user has their feet on the floor 19 for elevated work, the elastic means of the wheel supports 15-18 are compressed, and the platform 1 is bearing on the ground via the stabilisers 40-43.

Advantageously, each of the stabilisers 40-43 carries anti-slip pads 60-62, for example made of elastomer.

The lower surface of the pads 60-62 is advantageously provided with reliefs.

In the embodiment represented, two anti-slip pads 60-61 are assembled to the fixed part 50 and one anti-slip pad 62 is assembled to the movable part 51 of each stabiliser 40-43.

The pads 60 and 61 are advantageously protruding from one and a single piece, which is mounted to the fixed part 50.

Fastening the pads 60-62 is, for instance, achieved by screwing.

In other embodiments, fastening the pads 60-62 is achieved by force fitting.

When a user climbs onto the platform 1 in the deployed position, as represented in FIG. 1, the platform 1 rests on the ground on the anti-slip pads 60-62.

In a first configuration, the stabilisers 40-43 are folded, and the platform 1 rests on the pads 60-61 of the fixed part 50 of each stabiliser 40-44. The lift polygon of the platform, defined by the pads 60 and 61 of the stabilisers 40 to 43, thus has an optimised surface area.

Advantageously, in an enhanced safety configuration, the stabilisers 40-43 are deployed, and the platform 1 rests on the pads 60-61 of the fixed part 50 and on the pads 62 of the movable part 51 of each stabiliser 40-43.

The user can deploy all four stabilisers 40-43, or only some stabilisers, depending on needs and/or available space.

When the user has stepped down from the platform 1, the pads 60-62 are advantageously distant from the ground, and the user can control pivoting of the movable part 51 by pressing on the locking means 52 and vertically pressing on the movable part 51, against the return means 53. By releasing pressure on the movable part 51, the user then allows the movable part 51 to automatically bear against the fixed part 50 through a rotational movement by approximately 130°, in the embodiment represented.

In the foldback position, the movable part 51 of the stabiliser 40-43 is bearing against the locking means 52, this bearing point being held by a return means. The pad 62 carried by the movable part 51 is oriented upwardly.

To deploy the stabiliser 40-43, the user advantageously uses their foot, and pivots the movable part 51 to the deployed state represented in FIG. 2.

Fastening the stabiliser 40-43 to a spar 4, 5 of the climbing plane or a spar 8, 9 of the stand is, for example, achieved by screwing.

In some embodiments, the fixed part 50 of the stabiliser 40-43 is provided with a lateral groove with a shape complementary to that of the base of the spar 4, 5; 8, 9 to which the stabiliser 40-43 is fastened. The fixed part 50 is made from a metal alloy, such as steel or aluminium alloy, or from a polymer material or a composite material.

In the embodiment represented, the fixed part 50 is equipped with tabs on which holes 70, 71 through which members for fastening elements to the spars pass, such as screws, are provided.

The invention has many advantages.

The stabilisers 40-44 extend advantageously outwardly of the spars 4, 5, thereby not obstructing the user's feet when climbing to the workstation.

The stabiliser unfolding movement can be carried out using the foot, so the user does not need to bend down.

The stabiliser foldback movement can be controlled using the foot, so the user does not need to bend down.

The stabilisers returning to the foldback position, after controlling by the user, is automatic, without intervention from the user.

Once the stabiliser is deployed, when the user ascends the climbing plane, the pads 60-62 come into contact with the floor, and the user's weight generates a substantially vertical reaction force on the pad 62 of the movable part 51. This reaction force advantageously causes the locking means 52 to clamp between the movable part 51 and the fixed part 50. The locking means 52 is therefore securely held in place, prohibiting any release of the movable part 51 and ruling out any foldback of the movable part 51. The stabiliser 40-44 cannot be folded back when the user is climbing on the platform or is in the elevated workstation secured by the platform.

The platform has a reduced overall size, both in its deployed position for use and in its folded back position for storage or transport.

When folded back, the lateral barriers are disposed substantially parallel to the climbing plane, in the compact storage or transport position of the platform.

The invention finds application in steps or platforms, particularly individual rolling platforms or lightweight individual rolling platforms.

1. A height access device comprising a front leg, a rear leg and a floor, the front leg defining a climbing plane comprising at least one step extending in a space delimited by two spars, the front leg comprising two ground bearing feet, each foot being provided with a stabiliser rotatably movable between a storage position and a substantially horizontal deployed ground bearing position, each stabiliser comprising a fixed part and a movable part, the fixed part being mounted to a foot of the front leg, the movable part being rotatably mounted relative to the fixed part about an axis, externally to the space delimited by the spars of the front leg, between a deployed position and a folded position, wherein the front leg comprises wheels mounted to elastic means, the stabilisers of the front leg being distant from the ground and the wheels leaning on the ground as long as a user does not climb on the climbing plane, locking means being able to hold the movable part of each stabiliser in the deployed position.

2. The device according to claim 1, wherein, when the stabilisers of the climbing plane are in the deployed position, the locking means of each stabiliser, include a section extending between the movable part and the fixed part, the weight of a user climbing on the climbing plane causing the stabilisers of the climbing plane to bear on the ground and clamping of the locking means

3. The device according to claim 1, wherein the fixed part of each stabiliser of the climbing plane is mounted externally to the space delimited by the spars of the front leg.

4. The device according to claim 1, wherein for each stabiliser of the climbing plane, the locking means are rotatably movably mounted to the fixed part, between a position of holding the movable part of the stabiliser in the deployed position and a position of releasing the movable part of the stabiliser.

5. The device according to claim 4, wherein a return means is able to cause the movable part to move from its deployed position to its folded position when the locking means are in the release position.

6. The device according to claim 4, wherein the displacement of the locking means from their holding position to their release position is carried out against a return means.

7. The device according to claim 6, wherein the means for returning the locking means is an elastic leaf, preferably made of spring steel.

8. The device according to claim 5, wherein the means for returning the movable part comprises a torsion spring mounted to the axil of rotation of the movable part.

9. The device according to claim 1, wherein the rear leg forms a stand comprising at least one crossbeam extending in a space delimited by two spars, the rear leg comprising two ground bearing legs, each leg being equipped with a stabiliser rotatably movable between a storage position and a substantially horizontal deployed position bearing on the ground, each stabiliser comprising a fixed part and a movable part, the fixed part being mounted to a leg of the rear leg, the movable part being rotatably mounted relative to the fixed part about an axis, externally to the space defined by the spars of the rear leg, between a deployed position and a folded position, the rear leg comprises wheels mounted to elastic means, the stabilisers of the rear leg being distant from the ground and the wheels bearing on the ground unless a user climbs onto the climbing plane, locking means being able to hold the movable part of each stabiliser of the rear leg in the deployed position.

10. The device according to claim 9, wherein, when the stabilisers of the rear leg are in the deployed position, the locking means of each stabiliser include a section extending between the movable part and the fixed part, the weight of a user climbing on the climbing plane causing the stabilisers of the rear leg to bear on the ground and clamping of the locking means.

11. The device according to claim 9, wherein the fixed part of each stabiliser of the rear leg is mounted externally to the space delimited by the spars of the rear leg.

12. The device according to claim 9, wherein for each stabiliser of the rear leg, the locking means are rotatably movably mounted to the fixed part, between a position of holding the movable part of the stabiliser in the deployed position and a position of releasing the movable part of the stabiliser.

13. The device according to claim 12, wherein a return means is able to cause the movable part to move from its deployed position to its folded position, when the locking means are in the release position.

14. The device according to claim 12, wherein displacement of the locking means from their holding position to their release position is carried out against a return means.

15. The device according to claim 14, wherein the means for returning the locking means is an elastic leaf, preferably made of spring steel.

16. The device according to claim 13, wherein the means for returning the movable part comprises a torsion spring mounted to the axis of rotation of the movable part.

17. The device according to claim 1, comprising a guardrail mounted to the front plane, this guardrail comprising a pair of lateral barriers, each mounted articulated to a spar between a deployed position in which each barrier extends substantially perpendicularly to the front plane, and a folded back position.

18. The device according to claim 1, the device being an individual rolling platform IRP, or a lightweight individual rolling platform.
